(19) United States
(12) Patent Application Publication
(10) Pub. No.: US 2020/0409474 A1
(43) Pub. Date: Dec. 31, 2020

(54) ACCEPTANCE OF EXPECTED TEXT SUGGESTIONS

(71) Applicant: Microsoft Technology Licensing, LLC, Redmond, WA (US)

(72) Inventors: Claes-Fredrik Urban Mannby, Mercer Island, WA (US); Matthew McGlynn, Bellevue, WA (US); Yifan Wu, Redmond, WA (US)

(21) Appl. No.: 16/457,464

(22) Filed: Jun. 28, 2019

(51) Int. Cl. G06F 3/023; G06F 3/0488; G06F 3/0482

(52) U.S. Cl. CPC G06F 3/0237; G06F 3/0482; G06F 3/04886

(57) ABSTRACT

Methods, apparatuses, and computer program products are provided that enables a user to enter an acceptance command to accept text suggestions whether the text suggestions have been displayed to the user or not. In aspects, abbreviated text is entered by the user, which may correspond to a complete text, such as a complete word or a complete phrase. The user may also enter an acceptance input via a predetermined key or key combination that signals the user's acceptance of a text suggestion even though that text suggestion may not have been generated or displayed to the user in a user interface. Once the acceptance input is received, the text suggestion may be displayed in the user interface as a complete text that includes the abbreviated text.

### BACKGROUND

Predictive auto-complete text entry is a function implemented in some text handling tools to automatically complete the text of a word after only a limited amount of text entry, as little as 1 to 3 keystrokes in some cases. Predictive auto-complete text entry tools save the user time by having the user enter fewer keystrokes in order to enter a full word. Such tools are particularly valuable for text intensive applications (e.g., word processing applications, electronic mail applications), particularly considering the relatively small keyboard featured on portable devices. Predictive auto-complete text entry may also be referred to as “word completion” or “inline prediction.” Predictive auto-complete text entry improves efficiency of text entry (i.e., improves speed and reduces errors) by reducing the number of characters that must be entered by the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, apparatuses, and computer program products are provided that enable a user to enter an acceptance command to accept text suggestions expected by the user even though not yet displayed. In aspects, abbreviated text is entered by the user, which may correspond to a complete text of a greater number of characters, such as a complete word or a complete phrase. The user may also enter an acceptance input via a predetermined key or key combination that signals the user's acceptance of a text suggestion even though that text suggestion may not have been generated or displayed to the user in a user interface. Once the acceptance input is received, the text suggestion may be displayed in the user interface as a complete text that includes the abbreviated text.

In one implementation, a first keyboard input event and a second keyboard input event are received at an electronic device. The first keyboard input event may be interpreted as a first character input and the second keyboard input event may be interpreted as an acceptance input. In response to at least the acceptance input, a first complete word or phrase may be displayed in a graphical user interface, the complete word or phrase including the first character input and a portion not having been presented in the graphical user interface prior to receipt of the acceptance input.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a computing device that is equipped to accept and process text entry including the acceptance of expected text suggestions, according to an embodiment.

FIG. 2 shows a flowchart of a method for managing the acceptance of expected text suggestions, according to an embodiment.

FIG. 3 shows an example of a computing device that includes a text acceptor, according to an embodiment.

FIG. 4 shows an example of a text acceptor, according to an embodiment.

FIG. 5 shows an example of a display component displaying an abbreviated text entry along with a text suggestion, according to an example embodiment.

FIG. 6 shows an example of a display component displaying a complete word, according to an example embodiment.

FIG. 7 shows an example of a display component displaying an abbreviated text entry along with an acceptance input, according to an example embodiment.

FIG. 8 shows a flowchart of a method for managing an overriding input, according to an example embodiment.

FIG. 9 shows a flowchart of a method for managing a text suggestion that has been generated for an abbreviated text entry, according to an example embodiment.

FIG. 10 shows a flowchart of a method for managing a text suggestion that has not been generated for an abbreviated text entry, according to an example embodiment.

FIG. 11 shows a flowchart of a method for managing multiple text suggestions for an abbreviated text entry, according to an example embodiment.

FIG. 12 is a block diagram of an example computer system in which embodiments may be implemented.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

The example embodiments described herein are provided for illustrative purposes and are not limiting. The examples described herein may be adapted to any type of predictive auto-complete text entry system. Further structural and operational embodiments, including modifications/alterations, will become apparent to persons skilled in the relevant art(s) from the teachings herein.

Predictive auto-complete text entry is a function implemented in some text handling tools to automatically complete the text of a word or phrase after only a limited amount of text entry, as little as 1 to 3 keystrokes in some cases. Predictive auto-complete text entry tools save the user time by having the user enter fewer keystrokes in order to enter a full word or phrase. Predictive auto-complete text entry may also be referred to as “word completion” or “inline prediction” as the graphical placement of the text suggestion or text prediction may be within a body of a document or page. Predictive auto-complete text entry improves efficiency of text entry (i.e., improves speed and reduces errors) by reducing the number of characters that must be entered.

For example, a user may enter an abbreviated text (e.g., three keystrokes that may correspond to three characters), and the user may then see a complete word or phrase displayed in a user interface. At that point, the user may enter an acceptance input (e.g., a predetermined key such as any one of a Tab, Space or Enter key) to indicate the user's acceptance of the suggested text. Text suggestions are generated and displayed based on statistics and probabilities given current and preceding user inputs, user data, language models, etc., and may be displayed in a manner that differentiates the text suggestion from entered or previously accepted content. Sometimes, text suggestions are not always displayed or even determined, for example, to save processing cycles or bandwidth, to avoid distracting the user with a text suggestion that is not associated with a high confidence level, or to be more efficient because the benefit of auto-complete text entry may be low (e.g., few keystrokes saved considering the typing speed of the user).

However, as the user becomes accustomed to using predictive auto-complete text entry, the user may expect a text suggestion to always be provided, especially if one has been in the past for a particular abbreviated text. For example, the user may enter the abbreviated text and then the acceptance input regardless whether a text suggestion has been displayed in the user interface. In this case, the user is essentially requesting a text suggestion. If the user enters the acceptance input and no text suggestion is displayed and a tab/space/line return is inserted instead, this creates a disruptive and jarring experience for the user. Thus, to enable smooth and effortless use of inline predictions, it is advantageous to manage this case, in which the user expects a text suggestion to be provided. In one embodiment, when a text suggestion is available but not yet displayed, the acceptance input may be processed as if the text suggestion has been displayed, and the available text suggestion is deemed “accepted” and is displayed as such to the user. In another embodiment, when a text suggestion has not been generated, then a text suggestion request may be made, and the text suggestion may be displayed as “accepted” when it is ready. In either embodiment, when the text suggestion is accepted, the sequencing of the acceptance and the receiving of any further keystrokes may be maintained to ensure the accurate word or phrase is displayed.

Embodiments described herein enable an improved user experience with predictive auto-complete text entry. The user experience is improved when inline predictions are provided when they are most useful or likely to be accepted by the user or upon implicit (e.g., by entering the acceptance input) or explicit request of the user. Moreover, the functioning of the computing device and associated systems is also improved. For example, fewer computing resources (e.g., processor cycles, power, bandwidth) may be required than normal in providing inline predictions selectively rather than continuously, while still allowing for on-demand inline predictions. Processor cycles of the device of the user may be saved if fewer inline predictions are determined and/or displayed. Power may also similarly be saved. The inline prediction process may be implemented with multiple devices (e.g., in a cloud service implementation), and bandwidth may also be saved with selective inline predictions.

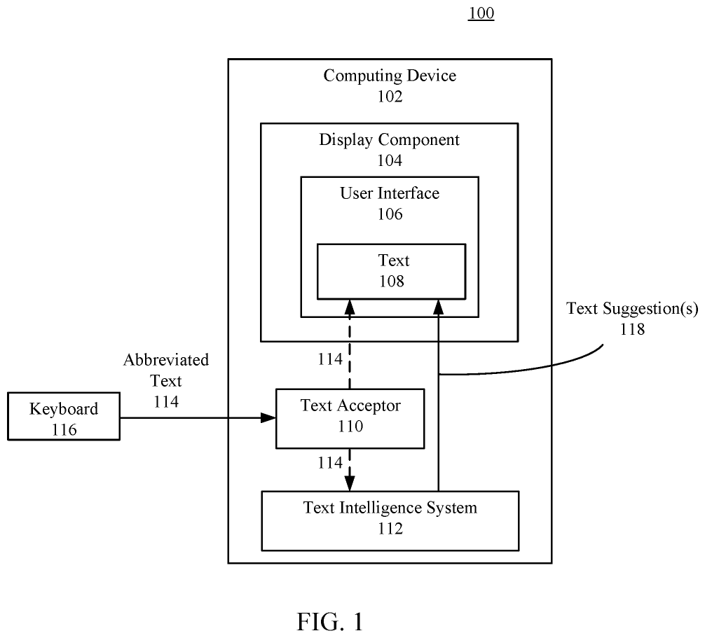

In embodiments, the acceptance of expected text suggestions may be implemented in a device in various ways. For instance, FIG. 1 shows a block diagram of a system 100 that includes a computing device 102 that is equipped to accept and process text entry, according to an example embodiment. As shown in FIG. 1, computing device 102 includes a display component 104, a text acceptor 110, and text intelligence system 112. Display component 104 includes a display screen that renders displayed text 108 in a displayed user interface 106. Computing device 102 may optionally include or is communicatively connected to a physical (e.g., hardware) keyboard 116. Computing device 102 and its components are described as follows.

Computing device 102 may be any type of mobile computer or computing device such as a handheld device (e.g., a Palm® device, a RIM Blackberry® device, a personal digital assistant (PDA)), a desktop computer, a laptop computer, a notebook computer, a tablet computer (e.g., an Apple iPad™, a Microsoft Surface™, etc.), a netbook, a mobile phone (e.g., a smart phone such as an Apple iPhone, a Google Android™ phone, a Microsoft Windows® phone, etc.), a wearable device (e.g., virtual reality glasses, helmets, and visors, a wristwatch (e.g., an Apple Watch®)), and other types of computing devices.

Display component 104 is a display of computing device 102 that is used to display text (textual characters, including alphanumeric characters, symbols, etc.) and optionally graphics, to users of computing device 102. The display screen may or may not be touch sensitive. Display component 104 may be an LED (light emitting diode)-type display, an OLED (organic light emitting diode)-type display, an LCD (liquid crystal display)-type display, a plasma display, or other type of display that may or may not be backlit.

Text acceptor 110 is configured to receive abbreviated text 114 provided by a user to computing device 102 via a keyboard (e.g., a virtual keyboard displayed in user interface 106 or keyboard 116). Computing device 102 may include and/or communicatively connected to one or more user input devices, such as physical keyboard 116, a thumb wheel, a pointing device, a roller ball, a stick pointer, a touch sensitive display, any number of virtual interface elements (e.g., such as a virtual keyboard or other user interface element displayed in user interface 106 by display component 104), and/or other user interface elements described elsewhere herein or otherwise known. In an embodiment, computing device 102 may include a haptic interface configured to interface computing device 102 with the user by the sense of touch, by applying forces, vibrations and/or motions to the user. For example, the user of computing device 102 may wear a glove or other prosthesis to provide the haptic contact. Keyboard 116 may include a plurality of user-actuatable components, such as buttons or keys with marks engraved or imprinted thereon, such as letters (e.g., A-Z), numbers (e.g., 0-9), punctuation marks (e.g., a comma, a period, a hyphen, a bracket, a slash), symbols (e.g., @, #, $) and special keys that may be associated with actions or act to modify other keys (e.g., Tab, Space, Enter, Caps Lock, Fn, Shift).

Abbreviated text 114 is a portion of a word or phrase, but not the entirety of the word of phrase, that a user is entering via a user input device (e.g., a virtual or physical keyboard) to computing device 102. In an embodiment, text acceptor 110 may store abbreviated text 114 (e.g., in memory or other storage), and provide abbreviated text 114 to display component 104 for display as shown in FIG. 1. Text acceptor 110 may provide abbreviated text to display component 104 in any form (e.g., as character data, display pixel data, rasterized graphics, etc.) Text acceptor 110 may also provide abbreviated text 114 to text intelligence system 112 for processing and translation according to one or more embodiments, as described in further detail below.

In an embodiment, user interface 106 is a graphic user interface (GUI) that includes a display region in which text 108 may be displayed. For instance, user interface 106 may be a graphical window of a word processing tool, an electronic mail (email) editor, or a messaging tool in which text may be displayed. User interface 106 may optionally be generated by text acceptor 110 for display by display component 104. In an embodiment, when providing abbreviated text 114 to display component 104 for display, text acceptor 110 may also provide indications or other information to identify a completed version of abbreviated text 114 (e.g., a word or phrase that the user is in the process of entering), such that display component 104 may render abbreviated text 114 in a manner that is different from other text. For example, when abbreviated text 114 is displayed in user interface 106 as text 108, the character corresponding to each keystroke being entered may be displayed in contrasting bold levels, different colors or shades, and/or otherwise rendered to permit a visual differentiation from other text.

In an embodiment, as noted above, text intelligence system 112 may receive abbreviated text 114 from text acceptor 110. In embodiments, text intelligence system 112 may be separate from text acceptor 110 (as shown in FIG. 1), or may be included in text acceptor 110. In other embodiments, text intelligence system may be separate from computing device 102 and accessible by computing device 102 over a network, such as a personal area network (PAN), a local area network (LAN), a wide area network (WAN), or a combination of networks such the Internet. For instance, text intelligence system 112 may be accessible by computing device 102 over a network at a server, such as in a web service, a cloud service, etc.

In an embodiment, and as described in greater detail below, text intelligence system 112 may be configured to receive abbreviated text 114 from text acceptor 110, and probabilistically determine one or more complete words or phrases likely to correspond to abbreviated text 114. Text intelligence system 112 may receive additional information (e.g., previous keystrokes) from text acceptor 110 to determine a text suggestion. For instance, in an embodiment, text intelligence system 112 may automatically receive abbreviated text 114 and determine whether a text suggestion should be determined, and if a text suggestion is to be generated, what the text suggestion should be for abbreviated text 114. In another embodiment, text acceptor 110 may determine whether a text suggestion should be generated and may request text intelligence system 112 for a text suggestion when one is needed.

As shown in FIG. 1, text intelligence system 112 generates one or more text suggestions 118, which in combination with abbreviated text 114, may be a full or complete text version of abbreviated text 114 received from the user via text acceptor 110. In embodiments, text suggestions 118 may include one or more portions, each of which may be combined with abbreviated text 114 to form a complete word or phrase. Thus, text suggestions 118 may be short with a few characters within a single word or much longer with multiple words forming phrases (e.g., sentences or paragraphs). For example, the user may enter the initial 5 keystrokes that correspond to the characters “hippo”, which may be abbreviated text 114. “Hippo” may be displayed in user interface 106 in a normal, standard or user-selected font and/or color, for example. As the user is entering the initial five keystrokes, the keystrokes input may be displayed in user interface 106 and provided to text intelligence system 112 simultaneously or with some delay. After any of the 1-5 initial keystrokes, text intelligence system 112 may determine a text suggestion of “hippopotamus”, which may be one of text suggestions 118, based at least on the initial keystrokes. Text suggestion “hippopotamus” may then be provided to display component 104 to be displayed as text 108, while the proper sequence of any further keyboard input event is maintained. For example, if the user continues to type another keystroke after the five initial keystrokes such that abbreviated text 114 is changed to “hippop”, text acceptor 110 may automatically account for the sixth keystroke and/or modify the text suggestion such that the word “hippopotamus” is accurately displayed as a complete word in user interface 106 to avoid any errors that may arise. For example, display component 104 may choose how to update user interface 106 as it receives each keystroke. Thus, for example, if the user types “hippopp” the system may choose to ignore the extra “p” as a common type of typographical (e.g., transpositions, adjacent key errors, and key bounces/stutters) and/or spelling (e.g., differentiating between “their” and “there” or “f” and “ph”) mistake. Alternatively, when the user types “hippopp” the text suggestion for the complete word of “hippopotamus” may be removed from user interface 106, causing the user to realize the typographical error of the extra “p”.

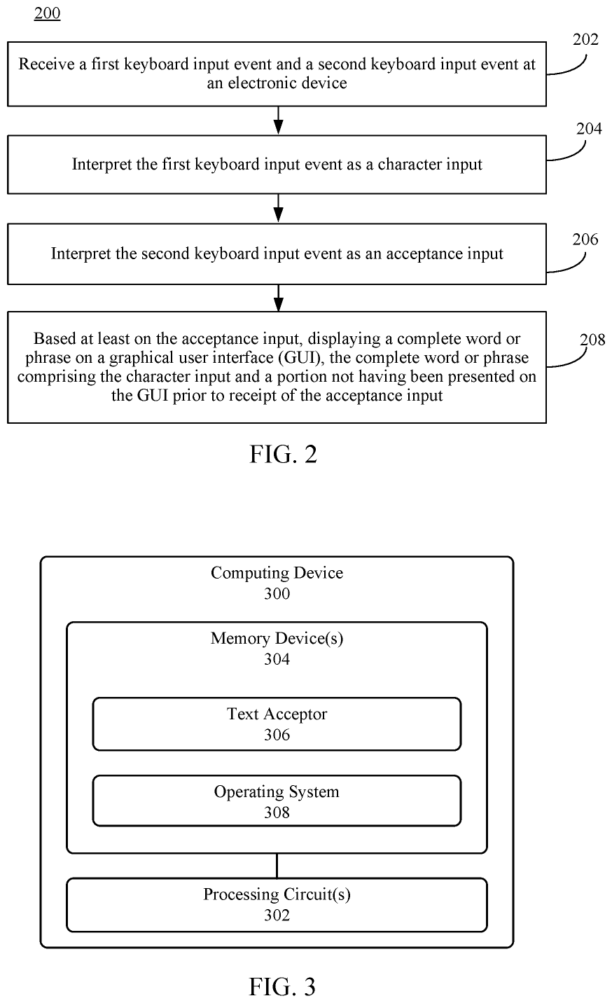

In embodiments, text acceptor 110 of computing device 102 may enable text acceptance in various ways. For instance, FIG. 2 shows an example method for managing the acceptance of expected text suggestions according to an embodiment. Although described with reference to system 100 of FIG. 1, the method of FIG. 2 is not limited to that implementation. Each step of flowchart 200 may be performed by computing device 102, in an embodiment. In other embodiments, the steps of flowchart 200 may be performed by modules or components of computing device 102 or of a separate device. For instance, any operations described hereinafter as being performed by text acceptor 110 may be integrated into one or more other modules, such as text intelligence system 112. Other structural and operational embodiments will be apparent to persons skilled in the relevant art(s) based on the following discussion regarding flowchart 200.

Flowchart 200 is an example method for managing the acceptance of expected text suggestions. Flowchart 200 begins at step 202. At step 202, a first keyboard input event and a second keyboard input event are received at an electronic device. For example, and with reference to system 100 of FIG. 1, text acceptor 110 may, as discussed above, receive a first keyboard input event and a second keyboard input event as abbreviated text 114. For example, the first and second keyboard input events may be received via one or more user input devices included or communicatively connected to computing device 102, such as a physical keyboard, a thumb wheel, a pointing device, a roller ball, a stick pointer, a touch sensitive display, any number of virtual interface elements (e.g., such as a virtual keyboard or any other user interface element) or haptic interface. In an embodiment, first and second keyboard input events may each be a pressing or releasing of a key or a combination of keys on a physical keyboard.

Continuing at step 204 of flowchart 200, the first keyboard input event is interpreted as a first character input. For example, text acceptor 110 may interpret the first keyboard input event, which may be received as abbreviated text 114 from the user typing a first keystroke on keyboard 116, as a first character input. A character input may include a letter, number, or a non-alphanumeric key, such as a punctuation mark or a symbol.

At step 206 of flowchart 200, the second keyboard input event is interpreted as an acceptance input. For example, text acceptor 110 may interpret the second keyboard input event, which may also be received as abbreviated text 114 from the user typing a second keystroke on keyboard 116, as an acceptance input. In embodiments, certain key or key combinations, such as Tab, Enter, Space, Alt and Shift, may be configured by the user or system to be interpreted as an acceptance input. In other embodiments, the acceptance input may be indicated via an audio command or a gesture from the user captured by a user input device, such as a voice recorder, video camera, or the like. In further embodiments, the acceptance key may be a key on the keyboard configured or specifically designed to be the acceptance key. The acceptance input may be a signal indicating that the user desires to accept a text suggestion, which may or may not have been displayed by display component 104 in user interface 106, as shown in FIG. 1. The acceptance key may have its own default or native functionality. For example, the main function of the Tab key is to advance the cursor to the next tab stop. The main function of the Enter key is to execute a command or to select options on a menu. And the main function of the Space key is to enter a space, for example, between words as the user types. Each of these special keys may also include other functionalities not described herein.

As the acceptance key may be system or user configurable, the acceptance key may have the sole function of being the acceptance key or it may function as the acceptance key when the appropriate condition(s) exist. For example, if the user enters the Tab key in the middle of a word (e.g., the user types several characters that do not form a complete word in English, for example, and then immediately strikes the Tab key), that Tab key input may be interpreted as an acceptance input. In this example, the condition is the acceptance input being received before the completion of a word. Thus, it is more likely that the user desires an insertion of a text suggestion than the user wanting to advance the cursor to the next tab stop or the next field. However, if the user has just finished typing a complete word, phrase or sentence (e.g., indicated by a space, comma or period following a word), and then strikes the Tab key, that Tab key may be interpreted according to its native functionality rather than as an acceptance input. In this example, the condition is the acceptance input being received after the completion of a word, phrase or sentence. In an embodiment, a keyboard input corresponding to a key is interpreted as an acceptance input only when it is entered mid-word or mid-phrase, and in the absence of this condition, that key may be interpreted according to its native functionality. Other rules and heuristics may be utilized to determine when an acceptance key is triggered as such.

In addition, in operation, a text suggestion may be displayed to the user only temporarily and may be converted to an accepted state or may disappear after a predetermined period of time or after the user starts typing through in disregard of the text suggestion. In an embodiment while a text suggestion is being displayed to the user, the acceptance key may be placed in a suspended state such that it may only be utilized as an acceptance input while its default or native functionality is temporarily suspended. When the text suggestion is no longer displayed in the user interface, the acceptance key may regain its native functionality. There may be an overriding measure provided, for example, if the user strikes the acceptance key twice mid-word, then the acceptance key may be interpreted according to its native functionality rather than as an acceptance input. As another overriding measure example, if the acceptance key is pressed and held for a predetermined period of time (e.g., longer than ⅓ of a second) then it may be interpreted according to its native functionality. Other overriding input may be utilized or configured by the system or user. In addition, a default interpretation may also be provided, for example, text acceptor 110 may interpret a key according to the native functionality of that key when there is some ambiguity about which input (e.g., default function input or acceptance input) is desired by the user. There may also be UI provided in the case of ambiguity, providing the two options, where e.g. one option is selected by waiting, and the other by pressing the acceptance key.

Flowchart 200 concludes at step 208, in which based at least on the acceptance input, a complete word or phrase is displayed in a graphical user interface (GUI), the complete word or phrase comprising the character input and a portion not having been presented in the GUI prior to receipt of the acceptance input. For example, as shown in FIG. 1, display component 104 may display a complete word or phrase in user interface 106, a complete word or phrase that includes the first character input and a textual portion not having been presented in user interface 106 prior to receipt of the acceptance input. Such textual portion may include one of text suggestions 118. The textual portion may be triggered to be displayed based on the acceptance input. For example, without the second keyboard input event that is interpreted as the acceptance input, there may be no acceptance of any text suggestion, whether or not displayed by display component 104 in user interface 106. The textual portion may be determined based on numerous factors, alone or in combination, such as the first keyboard input, preceding text, other user data (e.g., typing speed, typing preferences or other behavioral data with respect to typing or how the user interacts with computing device 102), word probabilities, phrase probabilities or language models, etc. In an embodiment, each of text suggestions 118 includes a textual portion that forms a complete word or phrase when combined with abbreviated text 114. In another embodiment, each of text suggestions 118 may include the full-text or complete word or phrase that already includes abbreviated text 114. And in such case, a text suggestion may completely replace abbreviated text 114.

In the foregoing discussion of flowchart 200, it should be understood that at times, the steps of flowchart 200 may be performed in a different order or even contemporaneously with other steps. For example, the receiving of a first keyboard input event and a second keyboard input event may be performed as different steps, or the interpreting the keyboard input events may be performed contemporaneously. Other operational embodiments will be apparent to persons skilled in the relevant art(s). Note also that the foregoing description of the operation of system 100 is provided for illustration only, and embodiments of system 100 may comprise different hardware and/or software, and may operate in manners different than described above.

For example, FIG. 3 is a block diagram of a computing device 300 that includes a text acceptor, according to an embodiment. Computing device 300 may be implemented as computing device 102 in system 100 of FIG. 1. Computing device 300 may include one or more processing circuits 302 connected to one or more memory devices 304.

Processing circuits 302 may include one or more microprocessors, each of which may include one or more central processing units (CPUs) or microprocessor cores. Processing circuits 302 may also include a microcontroller, application-specific integrated circuit (ASIC), field-programmable gate array (FPGA), and/or other processing circuitry. Processing circuit(s) 302 may operate in a well-known manner to execute computer programs (also referred to herein as computer program logic). The execution of such computer program logic may cause processing circuit(s) 302 to perform operations, including operations that will be described herein. Each component of computing device 300, such as memory devices 304 may be connected to processing circuits 302 via one or more suitable interfaces.

Memory devices 304 include one or more volatile and/or non-volatile memory devices. Memory devices 304 store a number of software components (also referred to as computer programs), including a text 306 that may be implemented as text acceptor 110 shown in FIG. 1. Memory devices 304 may also store other software components for example, operating system 308 or other components not shown in FIG. 3. Operating system 308 includes a set of programs that manage resources and provide common services for programs and systems, such as text acceptor 306. Text acceptor 306 may be implemented as a part of an application, a part of a software development kit available to multiple applications (e.g., messaging applications or other communication applications, text editors, web browsers, web-based applications), or a part of operating system 308.

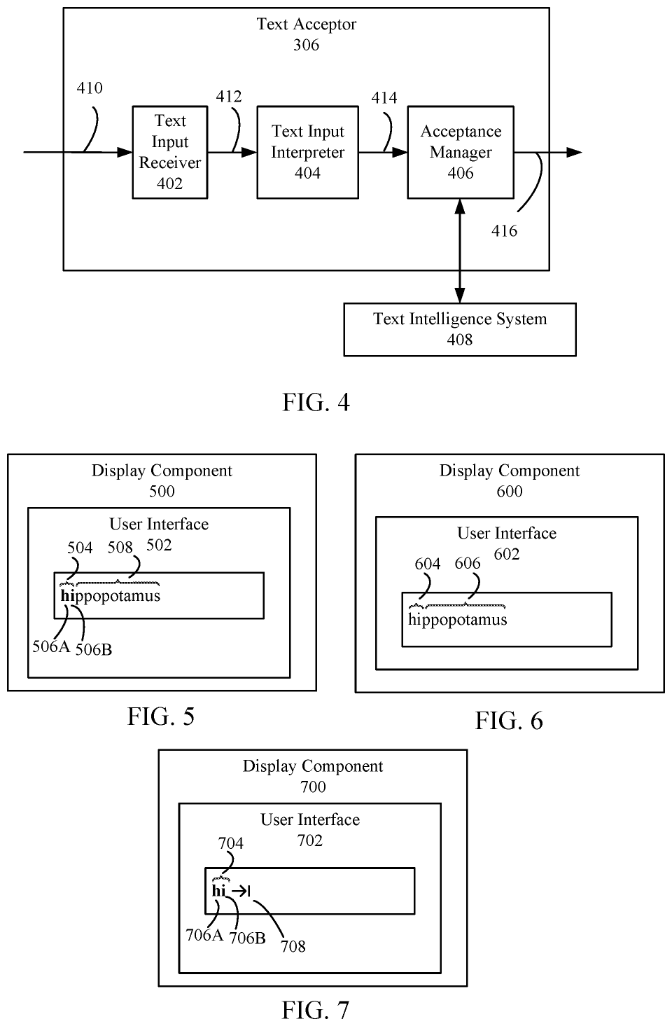

In an embodiment, text acceptor 306 may be configured in various ways to perform the steps associated with flowchart 200 described above. For instance, FIG. 4 shows an example of text acceptor 306, according to an embodiment. Text acceptor 306 includes a text input receiver 402, a text input interpreter 404, and an acceptance manager 406. Text acceptor 306 is configured to receive abbreviated text 410, and output at least one text suggestion 416 based on abbreviated text 410. The text acceptor 306 is described as follows.

Text input receiver 402 is configured to receive abbreviated text 410 (e.g., according to step 202 of FIG. 2), and forward the same to text input interpreter 404 as signal 412. Text input receiver 402 may also be configured to receive input data from the user input device or other sources and provide this information to text input interpreter 404. For example, signal 412 may include input data from a keyboard (e.g., keyboard 116 shown in FIG. 1). The input data may include key codes that correspond to keystrokes by the user. For example, text input receiver may detect a first keyboard input event based on input data signifying a key press or a key release of a first key. Input data may include information about the input device (e.g., serial number, version, model number, configuration data, layout data, etc.), information related to the input (e.g., type such as spatial or auditory), timing, sequence, typing speed), and other information. Thus, for example, the pressing of a combination of keys, multiple key presses (e.g., a key being pressed twice in quick succession), pressing and holding of keys, etc. may all be received by text input receiver 402. As described above, abbreviated text 410 may be an example of abbreviated text 114 shown in FIG. 1.

Text input interpreter 404 is configured to interpret signal 412, which includes input data that corresponds to abbreviated text 410. For example, text input interpreter may access information obtained from keyboard 116, stored in memory (e.g., memory devices 304 of computing device 300 shown in FIG. 3), or stored elsewhere about the keys and keyboard layout for keyboard 116. Text input interpreter may access a lookup table, for example, to translate from key codes to the corresponding characters or symbols. Accordingly, text input interpreter 404 may determine that a keyboard input event (e.g., the pressing or releasing of a key or key combination on keyboard 116) is a character input or an acceptance input. Furthermore, text input interpreter 404 is configured to interpret keyboard input based on any received input data. For example, a double key press of an acceptance key (e.g., a keyboard input being received at least twice in a predetermined time period) may be interpreted as an overriding input rather than an acceptance input. In an embodiment, the acceptance input may include at least one of a tab key input, a space key input, or an enter key input, and the overriding input may include the double pressing of any of the tab key input, the space key input, or the enter key input (or vice versa, i.e., the double pressing being reserved for the acceptance input). For example, when two Tab key inputs are received in quick succession, that double pressing of the Tab key is interpreted as an overriding input, and thus the cursor is moved to the next Tab stop rather than as an acceptance input to automatically complete the current word being typed. The interpretation of abbreviated text 410 is forwarded to acceptance manager 406 as signal 414. Text input interpreter 404 may also provide the interpretation of abbreviated text 410 to a display component, such as display component 104 shown in FIG. 1, for displaying abbreviated text 114 as text 108 in user interface 106 while the user is in the process of typing.

Acceptance manager 406 is configured to receive signal 414 and based at least on that, determine whether a text suggestion should be generated for abbreviated text 114. In some cases, if the user is typing too fast, it may not be worth it to expend resources to generate a text suggestion because the amount of text saved (e.g., the number of keystrokes saved by the user) with the text suggestion is too small. As a simple example, for a three-letter word, it may not be useful to determine a text suggestion because by the time the text suggestion is displayed to the user, the user may have already finished typing the word. Similarly, for the same example, if a text suggestion is shown after the second keystroke, the user may still have to enter a third keystroke to signal acceptance of the text suggestion (e.g., a Tab key input), and thus no keystroke is saved for that three-letter word. In an embodiment, the determination of whether a text suggestion should be generated may be determined by text intelligence system 408.

If it is determined that a text suggestion should be generated, acceptance manager is configured to determine a text suggestion 416 based at least on signal 414. In an embodiment, text suggestion 416 may be a full or complete text version of abbreviated text 410 received from the user via text acceptor. For example, text suggestion 416 may be a partial word or phrase and thus may be combined with abbreviated text 410 to form a complete or full-text word or phrase. As another example, text suggestion 416 may be a complete word or phrase that may replace abbreviated text 410 when displayed on a GUI. In an embodiment, acceptance manager 406 may forward signal 414 to text intelligence system 408, and any other data useful to determine a text suggestion (e.g., previous keystrokes or words entered by the user, user data pertaining to user typing speed, typing preferences or other behavioral data with respect to typing or how the user interacts with a particular device) and text intelligence system 408 may determine a text suggestion based at least on signal 414. The text suggestion from text intelligence system 408 may be transmitted to acceptance manager 406 to provide to a display component (e.g., display component 104 of FIG. 1) as text suggestion 416. Alternatively or additionally, the text suggestion may be directly provided to the display component by text intelligence system 408.

Text intelligence system 408 is shown as being separate from text acceptor 306, but may be implemented as part of text acceptor 306 or as a system on a separate device from the device that includes text acceptor 306. For example, text intelligence system 408 may be implemented in a cloud predictive auto-complete text service. In an embodiment, text intelligence system 408 may be implemented as text intelligence system 112 shown in FIG. 1. Text intelligence system 408 is configured to generate at least a text suggestion based on abbreviated text 410. Text intelligence system 408 may include or access a language modeling component that takes preceding and/or following text of abbreviated text 410 as input to generate text suggestions and/or to make needed corrections.

For example, text intelligence system 408 may include or utilize a language model, an error model, and UI components to respectively generate text suggestion, correct any error, and enable display of text to the user, for example, via display component 104 of FIG. 1. The language model may access language statistics for language modeling (e.g., generate text suggestion), such as global patterns of language use derived from a large, general population of users and/or individual or group patterns of language use derived from a single user or a group of which the user is a part. For example, a user in a particular profession or work for a company may use language specific to the profession or the company in addition to his/her own personal language. The error model may access statistics for language corrections, such as statistics about physical hardware (e.g., input device model or version, keyboard layout and/or configuration), statistics about dialects, pronunciations, spelling, grammar, word construction, and/or statistics about input (e.g., spatially input information, auditory input information). For example, the error model may analyze preceding and/or following text of abbreviated text 410 to determine what, if any, corrections are needed. As a specific example, abbreviated text 410 may be a part of a fifth word in a series of words, the third word in that series may be revised by analyzing the first two words and the last two words of the series. The UI components may enable text to be displayed in a user interface (e.g., user interface 106 of FIG. 1) in various ways. For example, there may be a text suggestion UI component for rendering text suggestion in a different color, different typeface, different font size, or some manner to distinguish the text suggestion from the input provided by the user. There may also be a text acceptance UI component for rendering text that has been accepted by the user in a manner that is different from how the text suggestion is displayed. For example, the accepted text may be rendered in the same manner and style as the text entered by the user (e.g., abbreviated text 410). Text intelligence system 408 may include other components.

In embodiments, text intelligence system 408 may generate a text suggestion with a corresponding probability that indicates a likelihood of the text suggestion being the correct text (e.g., word, phrase) that the user is trying to type. For example, for abbreviated text 410, text intelligence system 408 may generate a set of text suggestions that contains the five most likely words. In an embodiment, the set may consist of a predetermined number of tuples, each tuple having the form (word, word_probability), where word is the complete (full-text) word, and word_probability is the probability that the text entered by the user corresponds to that word. Thus, if abbreviated text 410 includes “ha” the set of text suggestions could be: [(“hand”, p1), (“hair”, p2), (“happy”, p3), (“happiness”, p4), (“harp”, p5)], where p1-p5 are the conditional probabilities corresponding to each word.

To determine the word_probability for each tuple in the set, text intelligence system 408 may use word lists, character-, syllable-, morpheme- or word-based language models that provide the probability of encountering words, and using methods known in the art, such as a table lookup, hash maps, tries, neural networks, Bayesian networks and the like, to find exact or fuzzy matches for a given abbreviated text. In embodiments, language models and algorithms work with words or parts of words, and can encode the likelihood of seeing another word or part of word after another based on specific words, word classes (such as “sports”), parts-of-speech (such as “noun”), or more complex sequences of such parts, for example, grammatical models, neural network models, such as Recurrent Neural Networks or Convolutional Neural Networks. In embodiments, the user data may be used in generating the word probability (e.g., the type or length of inline predictions that the user has accepted or typed through in the past, typing speed or typing tendencies, instances when the inline predictions have been rejected, etc.).

Text intelligence system 408 may also determine a phrase probability that indicates the likelihood of text suggestion being the correct phrase that the user is trying to type. The phrase probability may be based on the word probability for a particular abbreviated text. Similar to the set of word probabilities described above, the set of phrase probabilities may consist of a number of tuples, each tuple having the form (phrase, phrase_probability) where phrase is the complete phrase, and phrase_probability is the probability that the received abbreviated text corresponds to that phrase. Text intelligence system 408 may use word probabilities and algorithms, or phrase-based language models to determine likely matches for sequences of words based on the likelihood of the transition from one word to another. Such likelihood may be based on phrase lists and language models that provide the probability of encountering particular word sequences. The word probabilities and/or language models may not only encode the likelihood of seeing another word based on specific adjacent words, but also consider word classes (such as “sports”), parts-of-speech (such as “noun”), or more complex sequences of such parts, such as in grammar models or neural network models, such as Recurrent Neural Networks or Convolutional Neural Networks.

It should be noted that the sets and tuples described herein are merely exemplary, and no particular data structure, data format or processing should be inferred. In embodiments, receipt of abbreviated text 410 may occur continuously and the processing of abbreviated text 410 may occur as each keyboard input event is received. That is, as more keyboard input events are received, the word and/or phrase probabilities may be assessed and updated in real-time. For example, the determining or updating of word probabilities based on the most recently received keyboard input events may occur while the set of phrase probabilities is still being determined based on prior input.

In an embodiment, the word or phrase with the highest probability may be selected as the likely candidate and the text suggestion may be provided based on that word or phrase (e.g., a portion of that word or phrase may be provided as the text suggestion to account for the abbreviated text already displayed). In another embodiment, the word or phrase with the highest probability may not be selected as the likely candidate unless that highest probability is higher than a predetermined threshold and/or the highest probability is higher than the next highest probability by a certain delta amount (e.g., 10%). Thus, an absolute threshold as well as a relative threshold may be utilized. These thresholds may not be static. That is, the thresholds may change over time as text acceptor 306 and/or text intelligence system 408 learn more about the user and his/her interaction with the inline prediction process.

In an embodiment, acceptance manager 406 may further be configured to determine that a text suggestion has been generated on at least the first character input. For example, acceptance manager 406 may have received a text suggestion from text intelligence system 408 but has not yet provided it to display component 104 (or the display component 104 has not yet displayed the text suggestion) before the acceptance input is received from the user. In this embodiment, acceptance manager 406 may provide the generated text suggestion to display component 104, as shown in FIG. 1, for displaying in user interface 106 while maintaining a proper sequence of any further keyboard input event. In other words, acceptance manager 406 may manage this scenario in the same manner as if the text suggestion has been displayed to the user and the user has indicated acceptance of the text suggestion with the acceptance input. In addition, acceptance manager 406 may keep track of the typing flow of the user (e.g., in a buffer or some other memory device) and can thus track abbreviated text 410, the portion of the complete word or phrase that forms the text suggestion, and any subsequent keyboard input events received by text input receiver 402 after receipt of abbreviated text 410. In this manner, acceptance manager 406 may account for any additional keyboard input received and may make any necessary adjustment to the text suggestion, thus enabling display component 104 to display the abbreviated text 410, any additional keyboard input received, and the adjusted text suggestion in a coherent manner. Alternatively, if the text suggestion already includes the additional keyboard input in the proper order, acceptance manger 406 may also provide the text suggestion to display component 104 without any adjustment, and ignore the additional keyboard input.

In another embodiment, acceptance manager 406 may further be configured to determine that a text suggestion has not been generated on at least the first character input. For example, a text suggestion may not have been generated because the user is typing too fast and there has not been enough time to generate a text suggestion, a text suggestion may have been deemed to be unnecessary or not beneficial given the existing conditions, multiple text suggestions have been generated but none has been selected as a likely candidate or the probabilities of the multiple text suggestions are too similar to determine a likely candidate, etc. In this embodiment, acceptance manager 406 may request for a text suggestion from text intelligence system 408 based at least on the first character input. When a text suggestion is received from text intelligence system 408, acceptance manager 406 may provide the text suggestion to display component 104 to display in user interface 106, as shown in FIG. 1, while maintaining a proper sequence of receipt of any further keyboard input event, as described the above embodiment. Accordingly, text acceptor 306 may allow for on-demand inline predictions to be made.

In an embodiment, multiple text suggestions may be provided by text intelligence system 408 for display component 104 to display in user interface 106 (shown in FIG. 1). In this embodiment, the words or phrases corresponding to the multiple text suggestions may be displayed in a particular order (e.g., ranked from highest probability to lowest probability) or randomly. Each of the words or phrases may also be displayed with a corresponding identifier (e.g., a first word may be associated with the number 1, a second word may be associated with the number 2, and so on) to enable the user to select the desired word or phrase by pressing the appropriate numeric key on the keyboard corresponding to the desired word or phrase. In an embodiment, the user input device may be equipped with specifically designed button(s) or selector device to allow the user to select the desired word. In another embodiment, UI components (e.g., graphics, buttons) may be associated with the words or phrases and the user may select the desired word or phrase by clicking/selecting the corresponding UI component. In yet another embodiment, different acceptance keys may be configured for different forms of a word of a text suggestion. For example, one acceptance key may be configured for the basic form of a word, another for the gerund form of a word, and yet another for the past tense form of a word, e.g., “look”, “looking” and “looked”, respectively. Other acceptance means and/or method may be employed by text acceptor 306.

Text acceptor 306 may include other components not shown in FIG. 4, such as an acceptance key component to configure the acceptance key(s) or manage the acceptance input (e.g., receipt, interpretation and/or state handling to enable a key to be associated with multiple functionalities).

Text suggestions may be displayed in various manners. For instance, FIG. 5 shows an example of a display component 500 displaying an abbreviated text entry along with a text suggestion, according to an example embodiment. In this example, display component 500 includes a user interface 502 on which text may be rendered. For example, user interface 502 may render abbreviated text 504 that includes two characters “hi” corresponding to two keyboard inputs, 506A and 506B, respectively. Abbreviated text 504 is shown in bold to distinguish it from text suggestion 508 “ppopotamus”, which may be generated by a text intelligence system, such as text intelligence system 408 shown in FIG. 4, although abbreviated text 504 and text suggestion 508 may be displayed in any known manner. In combination, abbreviated text 504 and text suggestion 508 form a complete word “hippopotamus.” Inline predictions may usually be presented in this manner, where the user enters a few characters and then the system (e.g., text intelligence system 408) may generate the remaining characters to form a complete word, thereby saving the user the effort of entering the remaining characters. After seeing the complete word in user interface 502, the user may then enter the acceptance input (e.g., Tab key) and text suggestion 508 would then be rendered in a manner that blends in with abbreviated text 504, for example, as shown in FIG. 6.

FIG. 6 shows an example of a display component 600 displaying a complete word, according to an example embodiment. In this example, display component 600 includes a user interface 602 on which text may be rendered. For example, user interface 602 may render abbreviated text 604 next to text suggestion 606, and their combination forms the complete word “hippopotamus.” In this example, the user has accepted the text suggestion (whether it was shown to the user prior to or after the user has entered the acceptance input), thus text suggestion 606 and abbreviated text 604 are shown in the same stylistic manner.

In another instance, FIG. 7 shows an example of a display component displaying an abbreviated text entry along with an acceptance input, according to an example embodiment. In this example, display component 700 includes user interface 702 on which text may be rendered. For example, user interface 700 may render abbreviated text 704 that includes two characters “hi” corresponding to two keyboard inputs, 706A and 706B. This example illustrates the case of the user essentially requesting a text suggestion because the user enters an acceptance input 708 (Tab key) before a text suggestion is displayed. In operation, the Tab key may not be displayed, instead a text suggestion may be displayed when the user presses the Tab key. Thus, after entering abbreviated text 704 and acceptance input 708, a complete word may be shown that incorporates and stylistically blends in with abbreviated text 704, for example, as the complete word “hippopotamus” shown in FIG. 6.

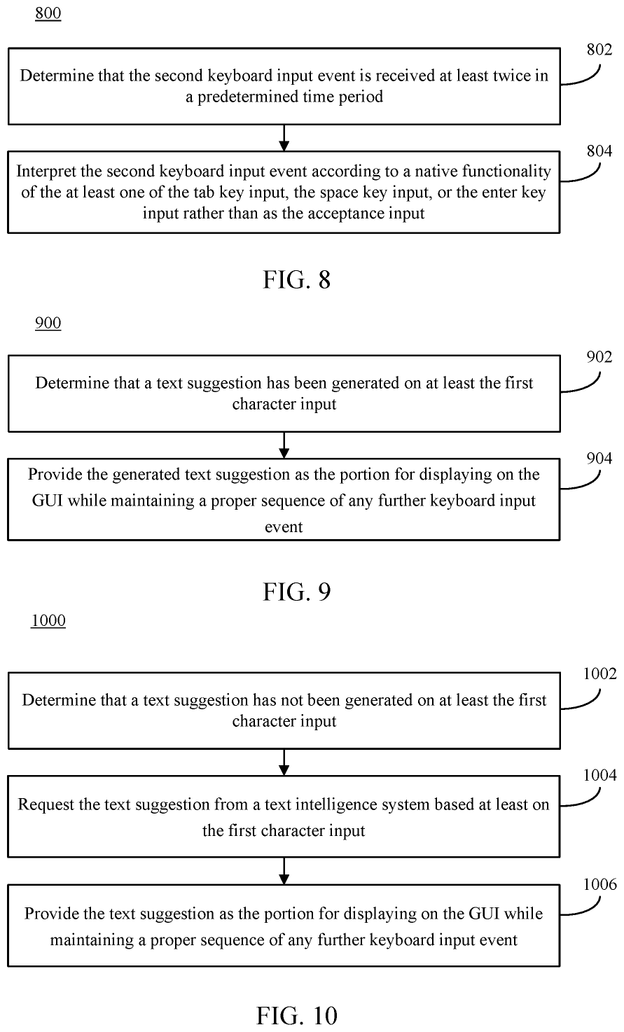

Text acceptor 306 may operate in various ways to enable the acceptance of expected text suggestions. FIGS. 8-11 show respective flowcharts 800-1100 that illustrate one or more of these various ways. Each step in these flowcharts may be implemented by one or more components of system 100 shown in FIG. 1 and/or computing device 300 shown in FIG. 3. For example, in an embodiment, text acceptor 306 may operate according to one or more steps of flowchart 200, and optionally perform additional steps. For example, embodiments may perform the steps of a flowchart 800 shown in FIG. 8 after or in addition to the steps of flowchart 200. In particular, FIG. 8 shows a flowchart of a method for managing an overriding input, according to an example embodiment. Flowchart 8 is described as follows.

In step 802, the second keyboard input event is determined to be received at least twice in a predetermined time period. In an embodiment, text input receiver 402 shown in FIG. 4 may receive a keyboard input twice or some higher number in a predetermined time period (e.g., 3 seconds). The predetermined time period may be system or user configurable, for example, it may be set to a short period of time, just enough to capture quick successive keystrokes entered by the user (e.g., double presses).

In step 804, the second keyboard input event is interpreted according to a native functionality of at least one of the Tab key input, the Space key input, or the Enter key input rather than as the acceptance input. In an embodiment, text input interpreter 404 shown in FIG. 4 may perform this step. When the acceptance key is at least one of the Tab key, the Space key, or the Enter key, any one of these inputs would be interpreted as an acceptance input, thereby triggering the display of a complete word or phrase formed by an abbreviated text entered by the user and a system generated text suggestion. However, when the acceptance key is pressed twice in quick succession, this is interpreted as an overriding input rather than an acceptance input. In this case of an override, each of the acceptance keys may be interpreted and displayed according to their native functionality. For example, the Tab key may be displayed to the user as a field hop or a cursor move, the Space key may be displayed as a space, and the Enter key may be displayed as a line return.

Text acceptor 306 may operate in another way to enable the acceptance of expected text suggestions. For example, in an embodiment, text acceptor 306 may operate according to one or more steps of flowchart 200, and optionally perform additional steps. For example, embodiments may perform the steps of a flowchart 900 shown in FIG. 9 after or in addition to the steps of flowchart 200. In particular, FIG. 9 shows a flowchart of a method for managing a text suggestion that has been generated for an abbreviated text entry, according to an example embodiment. Flowchart 9 is described as follows.

In step 902, in which it is determined that a text suggestion has been generated on at least the first character input. In an embodiment, acceptance manager 406 shown in FIG. 4 is configured to determine that a text suggestion has been generated based at least on the first character input. In this case, while a text suggestion has been generated, it may not have been displayed to the user for various reasons, such as the user has been typing too fast and there is not adequate time to display the text suggestion on a display component, such as display component 104 shown in FIG. 1.

In step 904, the generated text suggestion is provided as the portion for display in the GUI while maintaining a proper sequence of any further keyboard input event. In an embodiment, acceptance manager 406 shown in FIG. 4 is further configured to provide the generated text suggestion as the portion for display in the GUI (e.g., user interface 106 shown in FIG. 1) while maintaining a proper sequence of any further keyboard input event. In an embodiment, the generated text suggestion may have been generated by text intelligence system 408, but may not have been displayed to the user prior to receiving the acceptance input. According to this embodiment, the generated text suggestion is treated as normal, e.g., as though it has already been displayed and the user has accepted the text suggestion after seeing it.

Text acceptor 306 may operate in still another way to enable the acceptance of expected text suggestions. For example, in an embodiment, text acceptor 306 may operate according to one or more steps of flowchart 200, and optionally perform additional steps. For example, embodiments may perform the steps of a flowchart 1000 shown in FIG. 10 after or in addition to the steps of flowchart 200. In particular, FIG. 10 shows a flowchart of a method for managing a text suggestion that has not been displayed for an abbreviated text entry, according to an example embodiment. Flowchart 10 is described as follows.

In step 1002, in which it is determined that a text suggestion has not been generated on at least the first character input. In an embodiment, acceptance manager 406 shown in FIG. 4 is configured to determine that a text suggestion has not been generated based at least on the first character input. In this case, a text suggestion may not have been generated for various reasons, such as the user has been typing too fast thereby the number of keystrokes that may be saved may be too little, due to inadequate time to generate a text suggestion, to save computing resources and/or bandwidth or the like, or the probabilities of the candidates found by text intelligence system 408 may not be sufficient to surpass certain thresholds or satisfy rules for displaying any of the candidates.

In step 1004, the text suggestion is requested from a text intelligence system based at least on the character input. In an embodiment, acceptance manager 406 shown in FIG. 4 is configured to request a text suggestion from a text intelligence system based at least on the first character input.

In step 1006, the text suggestion is provided as the portion for display in the GUI while maintaining a proper sequence of any further keyboard input event. In an embodiment, acceptance manager 406 shown in FIG. 4 is further configured to provide the text suggestion as the portion for display in the GUI (e.g., user interface 106 shown in FIG. 1) while maintaining a proper sequence of any further keyboard input event.

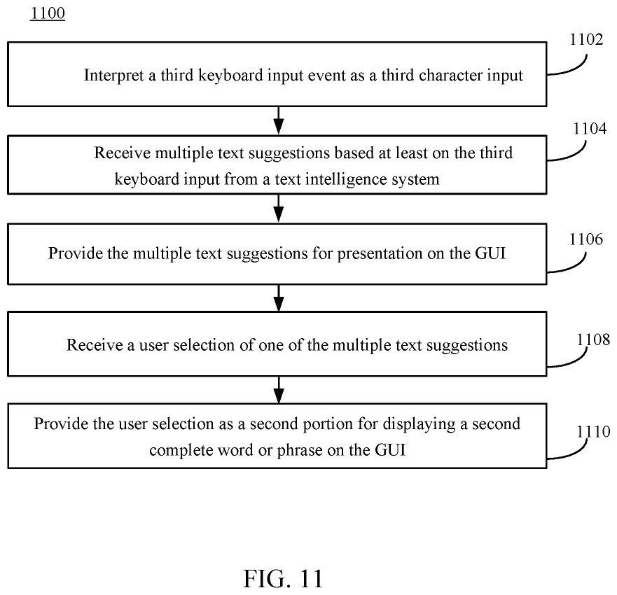

Text acceptor 306 may operate in yet another way to enable the acceptance of expected text suggestions. For example, in an embodiment, text acceptor 306 may operate according to one or more steps of flowchart 200, and optionally perform additional steps. For example, embodiments may perform the steps of a flowchart 1100 shown in FIG. 11 after or in addition to the steps of flowchart 200. In particular, FIG. 11 shows a flowchart of a method for managing multiple text suggestions for an abbreviated text entry, according to an example embodiment. Flowchart 11 is described as follows.

In step 1102, a third keyboard input event is interpreted as a third character input. For example, in an embodiment, text input receiver 402 shown in FIG. 4 is configured to interpret a third keyboard event as a third character input.

In step 1104, multiple text suggestions are received based at least on the third keyboard input from a text intelligence system. For example, in an embodiment, acceptance manager 406 shown in FIG. 4 is configured to receive multiple text suggestions based at least on the third character input from a text intelligence system (e.g., text intelligence system 408 shown in FIG. 4). The multiple text suggestions may be associated with corresponding probabilities (e.g., word and/or phrase) and corresponding identifiers, for example, numerical, graphical, color-based, or any other manner that may be used by the user to identify and/or select the text suggestions. In an embodiment, the corresponding probabilities are not displayed to the user but may be used to rank or order the multiple text suggestions for presentation. In another embodiment, the corresponding probabilities may be displayed to the user in some manner.

In step 1106, the multiple text suggestions are provided for presentation on the GUI. For example, in an embodiment, acceptance manager 406 shown in FIG. 4 is configured to provide the multiple text suggestions for presentation on the GUI. The multiple text suggestions may be presented as complete words or phrases, each of which may include at least the third keyboard input. The multiple text suggestions may also be presented with their corresponding identifiers in a particular order (e.g., predefined as configured by the user or system or based on one or more rules) or a random order.

In step 1108, a user selection of one of the multiple text suggestions is received. For example, in an embodiment, acceptance manager 406 shown in FIG. 4 is configured to receive a user selection of one of the multiple text suggestions. For example, acceptance manager 406 may receive it from text input receiver 402 and/or text input interpreter 404 as part of signal 414. In another example, text acceptor 306 may include another communication module that interfaces with a user input device (e.g., a video camera, an auditory device, etc.) to receive user input that may indicate a selection of one of the multiple text suggestions. In an embodiment, acceptance manager 406 may treat the received user selection as an acceptance input (e.g., as described elsewhere herein) and may manage the user selection in a similar manner.

In step 1110, the user selection is provided as a second portion for a displaying a second complete word or phrase on the GUI. For example, in an embodiment, acceptance manager 406 shown in FIG. 4 is configured to provide the user selection as a second portion for displaying a second complete word or phrase in the GUI (e.g., user interface 106 shown in FIG. 1).

In the foregoing discussion of the steps of flowcharts 800-1100, it should be understood that at times, such steps may be performed in a different order or even contemporaneously with other steps. For example, the steps may be performed in a different order or even simultaneously. Other operational embodiments will be apparent to persons skilled in the relevant art(s). Note also that the foregoing general description of the operation of system 100 and/or computing device 300 is provided for illustration only, and embodiments of system 100 and computing device 300 may comprise different hardware and/or software, and may operate in manners different than described above.

### III. Example Computer System Implementation

Each of display component 104, text acceptor 110, text intelligence system 112, keyboard 116, text acceptor 306, text input receiver 402, text input interpreter 404, acceptance manager 406, and/or text intelligence system 408, and flowcharts 200 and/or 800-1100 may be implemented in hardware, or hardware combined with software and/or firmware. For example, display component 104, text acceptor 110, text intelligence system 112, keyboard 116, text acceptor 306, text input receiver 402, text input interpreter 404, acceptance manager 406, and/or text intelligence system 408, and flowcharts 200 and/or 800-1100 may be implemented as computer program code/instructions configured to be executed in one or more processors and stored in a computer readable storage medium. Alternatively, display component 104, text acceptor 110, text intelligence system 112, keyboard 116, text acceptor 306, text input receiver 402, text input interpreter 404, acceptance manager 406, and/or text intelligence system 408, and flowcharts 200 and/or 800-1100 may be implemented as hardware logic/electrical circuitry.

For instance, in an embodiment, one or more, in any combination, of display component 104, text acceptor 110, text intelligence system 112, keyboard 116, text acceptor 306, text input receiver 402, text input interpreter 404, acceptance manager 406, and/or text intelligence system 408, and flowcharts 200 and/or 800-1100 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

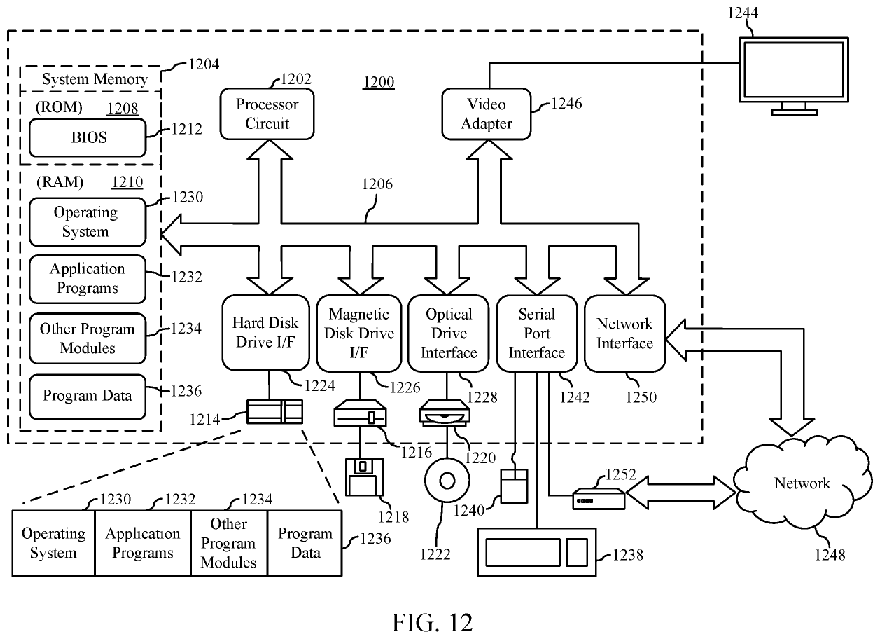

FIG. 12 depicts an exemplary implementation of a computing device 1200 in which embodiments may be implemented. For example, display component 104, text acceptor 110, text intelligence system 112, keyboard 116, text acceptor 306, text input receiver 402, text input interpreter 404, acceptance manager 406, and/or text intelligence system 408 may each be implemented in one or more computing devices similar to computing device 1200 in stationary or mobile computer embodiments, including one or more features of computing device 1200 and/or alternative features. The description of computing device 1200 provided herein is provided for purposes of illustration, and is not intended to be limiting. Embodiments may be implemented in further types of computer systems, as would be known to persons skilled in the relevant art(s).

As shown in FIG. 12, computing device 1200 includes one or more processors, referred to as processor circuit 1202, a system memory 1204, and a bus 1206 that couples various system components including system memory 1204 to processor circuit 1202. Processor circuit 1202 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1202 may execute program code stored in a computer readable medium, such as program code of operating system 1230, application programs 1232, other programs 1234, etc. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computing device 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1230, one or more application programs 1232, other programs 1234, and program data 1236. Application programs 1232 or other programs 1234 may include, for example, computer program logic (e.g., computer program code or instructions) for implementing display component 104, text acceptor 110, text intelligence system 112, keyboard 116, text acceptor 306, text input receiver 402, text input interpreter 404, acceptance manager 406, and/or text intelligence system 408, and flowcharts 200 and/or 800-1100 (including any suitable step of flowcharts 200 and/or 800-1100), and/or further embodiments described herein.

A user may enter commands and information into the computing device 1200 through input devices such as keyboard 1238 and pointing device 1240. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1202 through a serial port interface 1242 that is coupled to bus 1206, but may be connected by other interfaces, such as a parallel port, game port, or a universal serial bus (USB).

A display screen 1244 is also connected to bus 1206 via an interface, such as a video adapter 1246. Display screen 1244 may be external to, or incorporated in computing device 1200. Display screen 1244 may display information, as well as being a user interface for receiving user commands and/or other information (e.g., by touch, finger gestures, virtual keyboard, etc.). In addition to display screen 1244, computing device 1200 may include other peripheral output devices (not shown) such as speakers and printers.

Computing device 1200 is connected to a network 1248 (e.g., the Internet) through an adaptor or network interface 1250, a modem 1252, or other means for establishing communications over the network. Modem 1252, which may be internal or external, may be connected to bus 1206 via serial port interface 1242, as shown in FIG. 12, or may be connected to bus 1206 using another interface type, including a parallel interface.

As used herein, the terms “computer program medium,” “computer-readable medium,” and “computer-readable storage medium” are used to refer to physical hardware media such as the hard disk associated with hard disk drive 1214, removable magnetic disk 1218, removable optical disk 1222, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1232 and other programs 1234) may be stored on the hard disk, magnetic disk, optical disk, ROM, RAM, or other hardware storage medium. Such computer programs may also be received via network interface 1250, serial port interface 1242, or any other interface type. Such computer programs, when executed or loaded by an application, enable computing device 1200 to implement features of embodiments described herein. Accordingly, such computer programs represent controllers of the computing device 1200.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A computer-implemented method for accepting a text suggestion is described herein. The method includes: receiving a first keyboard input event and a second keyboard input event at an electronic device; interpreting the first keyboard input event as a first character input; interpreting the second keyboard input event as an acceptance input; and based at least on the acceptance input, displaying a first complete word or phrase in a graphical user interface (GUI), the complete word or phrase comprising the first character input and a portion not having been presented in the GUI prior to receipt of the acceptance input.

In an embodiment of the foregoing method, the first keyboard input event and the second keyboard input event are physical keyboard input events.

In another embodiment of the foregoing method, the acceptance input comprises at least one of a tab key input, a space key input, or an enter key input.

One embodiment of the foregoing method further comprises determining that the second keyboard input event is received at least twice in a predetermined time period; and interpreting the second keyboard input event according to a native functionality of the at least one of the tab key input, the space key input or the enter key input rather than as the acceptance input.

In another embodiment of the foregoing method, the displaying includes: determining that a text suggestion has been generated on at least the first character input; and providing the generated text suggestion as the portion for displaying in the GUI while maintaining a proper sequence of any further keyboard input event.

In an additional embodiment of the foregoing method, the displaying includes: determining that a text suggestion has not been generated on at least the first character input; requesting the text suggestion from a text intelligence system based at least on the first character input; and providing the text suggestion as the portion for displaying in the GUI while maintaining a proper sequence of any further keyboard input event.

An additional embodiment of the foregoing method further comprises interpreting a third keyboard input event as a third character input; receiving multiple text suggestions based at least on the third character input from a text intelligence system; providing the multiple text suggestions for presentation on the GUI; receiving a user selection of one of the multiple text suggestions; and providing the user selection as a second portion for displaying a second complete word or phrase on the GUI.

A system is described herein. In one embodiment, the system comprises: a processing circuit; and a memory device connected to the processing circuit, the memory device storing program code that is executable by the processing circuit, the program code comprising: a text input receiver configured to receive a first keyboard input event and a second keyboard input event; a text input interpreter configured to interpret the first keyboard input event as a first character input and the second keyboard input event as an acceptance input; and an acceptance manager configured to display a complete word or phrase in a graphical user interface (GUI), the complete word or phrase comprising the first character input and a portion not having been presented in the GUI prior to receipt of the acceptance input.

In an embodiment of the foregoing system, the first keyboard input event and the second keyboard input event are physical keyboard input events.

In another embodiment of the foregoing system, the acceptance input comprises at least one of a tab key input, a space key input, or an enter key input.

In one embodiment of the foregoing system, the text input receiver is further configured to determine that the second keyboard input event is received at least twice in a predetermined time period, and the text input interpreter is further configured to interpret the second keyboard input event according to a native functionality of the at least one of the tab key input, the space key input or the enter key input rather than as the acceptance input.

In another embodiment of the foregoing system, the acceptance manager is further configured to determine that a text suggestion has been generated on at least the first character input; and provide the generated text suggestion as the portion for displaying on the GUI while maintaining a proper sequence of any further keyboard input event.

In yet another embodiment of the foregoing system, the acceptance manager is further configured to determine that a text suggestion has not been generated on at least the first character input; request the text suggestion from a text intelligence system based at least on the first character input; provide the text suggestion as the portion for displaying in the GUI while maintaining a proper sequence of receipt of any further keyboard input event.

In still another embodiment of the foregoing system, the text input interpreter is further configured to interpret a third keyboard input event as a third character input; and the acceptance manager is further configured to receive multiple text suggestions based at least on the third character input from a text intelligence system; provide the multiple text suggestions for presentation on the GUI; receive a user selection of one of the multiple text suggestions; and provide the user selection as a second portion for displaying a second complete word or phrase on the GUI.

A computer program product comprising a computer-readable memory device having computer program logic recorded thereon that when executed by at least one processor of a computing device causes the at least one processor to perform operations is described herein. In one embodiment of the computer program product, the operations comprise: receiving a first keyboard input event and a second keyboard input event at an electronic device; interpreting the first keyboard input event as a first character input; interpreting the second keyboard input event as an acceptance input; and based at least on the acceptance input, displaying a complete word or phrase in a graphical user interface (GUI), the complete word or phrase comprising the first character input and a portion not having been presented in the GUI prior to receipt of the acceptance input.

In an embodiment of the foregoing computer program product, the first keyboard input event and the second keyboard input event are physical keyboard input events.

In another embodiment of the foregoing computer program product, the acceptance input comprises at least one of a tab key input, a space key input, or an enter key input.

In an additional embodiment of the foregoing computer program product, the operations further include: determining that the second keyboard input is received at least twice in a predetermined time period; and interpreting the second keyboard input according to a native functionality of the at least one of the tab key input, the space key input or the enter key input rather than as the acceptance input.

In yet another embodiment of the foregoing computer program product, the displaying further includes: determining that a text suggestion has been generated on at least the first character input; and providing the generated text suggestion as the portion for displaying in the GUI while maintaining a proper sequence of any further keyboard input event.

In yet another embodiment of the foregoing computer program product, the displaying further includes: determining that a text suggestion has not been generated on at least the first character input; requesting for the text suggestion from a text intelligence system based at least on the first character input; and providing the text suggestion as the portion for displaying in the GUI while maintaining a proper sequence of any further keyboard input event.

### V. Conclusion

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

1. A computer-implemented method of accepting a text suggestion, comprising:
receiving a first keyboard input event at an electronic device;
interpreting the first keyboard input event as a first character input;
determining a first complete word or phrase based on the first character input;
receiving a second keyboard input event at the electronic device;
interpreting the second keyboard input event as an acceptance input; and
based at least on the acceptance input, displaying the determined first complete word or phrase in a graphical user interface (GUI), the determined first complete word or phrase comprising the first character input and a portion not having been presented in the GUI prior to receipt of the acceptance input.

2. The computer-implemented method of claim 1, wherein the first keyboard input event and the second keyboard input event are physical keyboard input events.

3. The computer-implemented method of claim 1, wherein the acceptance input comprises at least one of a tab key input, a space key input, or an enter key input.

4. The computer-implemented method of claim 3, further comprising:
determining that the second keyboard input event is received at least twice in a predetermined time period; and
interpreting the second keyboard input event according to a native functionality of the at least one of the tab key input, the space key input or the enter key input rather than as the acceptance input.

5. The computer-implemented method of claim 1, wherein said displaying comprises:
determining that a text suggestion has been generated on at least the first character input; and
providing the generated text suggestion as the portion for displaying in the GUI while maintaining a proper sequence of any further keyboard input event.

6. The computer-implemented method of claim 1, wherein said displaying comprises:
determining that a text suggestion has not been generated on at least the first character input;
requesting the text suggestion from a text intelligence system based at least on the first character input; and
providing the text suggestion as the portion for displaying in the GUI while maintaining a proper sequence of any further keyboard input event.

7. The computer-implemented method of claim 1, further comprising,
interpreting a third keyboard input event as a third character input;
receiving multiple text suggestions based at least on the third character input from a text intelligence system;
providing the multiple text suggestions for presentation in the GUI;
receiving a user selection of one of the multiple text suggestions; and
providing the user selection as a second portion for displaying a second complete word or phrase in the GUI.

8. A system, comprising:
a processing circuit; and
a memory device connected to the processing circuit, the memory device storing program code that is executable by the processing circuit, the program code comprising:
a text input receiver configured to receive a first keyboard input event;
a text input interpreter configured to:
interpret the first keyboard input event as a first character input;
determine a first complete word or phrase based on the first character input; and
interpret a second keyboard input event subsequently received by the text input receiver as an acceptance input; and
an acceptance manager configured to display the determined first complete word or phrase in a graphical user interface (GUI), the determined first complete word or phrase comprising the first character input and a portion not having been presented in the GUI prior to receipt of the acceptance input.

9. The system of claim 8, wherein the first keyboard input event and the second keyboard input event are physical keyboard input events.

10. The system of claim 8, wherein the acceptance input comprises at least one of a tab key input, a space key input, or an enter key input.

11. The system of claim 10, wherein the text input receiver is further configured to determine that the second keyboard input event is received at least twice in a predetermined time period; and
wherein the text input interpreter is further configured to interpret the second keyboard input event according to a native functionality of the at least one of the tab key input, the space key input or the enter key input rather than as the acceptance input.

12. The system of claim 8, wherein the acceptance manager is further configured to:
determine that a text suggestion has been generated on at least the first character input; and
provide the generated text suggestion as the portion for displaying in the GUI while maintaining a proper sequence of any further keyboard input event.

13. The system of claim 8, wherein the acceptance manager is further configured to:
determine that a text suggestion has not been generated on at least the first character input;
request the text suggestion from a text intelligence system based at least on the first character input; and
provide the text suggestion as the portion for displaying in the GUI while maintaining a proper sequence of receipt of any further keyboard input event.

14. The system of claim 8,
wherein the text input interpreter is further configured to:
interpret a third keyboard input event as a third character input; and
wherein the acceptance manager is further configured to:
receive multiple text suggestions based at least on the third character input from a text intelligence system;
provide the multiple text suggestions for presentation in the GUI;
receive a user selection of one of the multiple text suggestions; and
provide the user selection as a second portion for displaying a second complete word or phrase in the GUI.

15. A computer program product comprising a computer-readable memory device having computer program logic recorded thereon that when executed by at least one processor of a computing device causes the at least one processor to perform operations, the operations comprising:
receiving a first keyboard input event and a second keyboard input event at an electronic device;
interpreting the first keyboard input event as a first character input;
determining whether the second keyboard input is received at least twice in a predetermined time period;
responsive to determining that the second keyboard input is received at least twice in the predetermined time period, interpreting the second keyboard input according to a native functionality of a corresponding key via which the second keyboard input is received; and
responsive to determining that the second keyboard input is not received at least twice in the predetermined time period, interpreting the second keyboard input event as an acceptance input.

16. The computer program product of claim 15, wherein the first keyboard input event and the second keyboard input event are physical keyboard input events.

17. The computer program product of claim 15, wherein the acceptance input comprises at least one of a tab key input, a space key input, or an enter key input.

18. (canceled)

19. The computer program product of claim 15, wherein said displaying further comprise:
determining that a text suggestion has been generated on at least the first character input; and
providing the generated text suggestion as the portion for displaying in a graphical user interface (GUI) while maintaining a proper sequence of any further keyboard input event.

20. The computer program product of claim 15, wherein said displaying further comprise:
determining that a text suggestion has not been generated on at least the first character input;
requesting for the text suggestion from a text intelligence system based at least on the first character input; and
providing the text suggestion as the portion for displaying in a graphical user interface (GUI) while maintaining a proper sequence of any further keyboard input event.

21. The computer program product of claim 15, further comprising:
based at least on the acceptance input, displaying a complete word or phrase in a graphical user interface (GUI, the complete word or phrase comprising the first character input and a portion not having been presented in the GUI prior to receipt of the acceptance input.
